(19) United States
(12) Patent Application Publication
(10) Pub. No.: US 2004/0152800 A1
(43) Pub. Date: Aug. 5, 2004

(54) Photo-crosslinkable, crystalline, polyaxial, absorbable polyester for rapid prototyping

(76) Inventors: Shalaby W. Shalaby, Anderson, SC (US); R. Larry Dooley, Clemson, SC (US); Joseph A. Pilgrim, Pendleton, SC (US)

Correspondence Address: LEIGH P. GREGORY, ATTORNEY AT LAW, PO BOX 168, CLEMSON, SC, 29633-0168, US

(21) Appl. No.: 10/683,059

(22) Filed: Oct. 9, 2003

Related U.S. Application Data
(60) Provisional application No. 60/417,376, filed on Oct. 9, 2002.

(51) Int. Cl. C08J 3/28; C08F 2/46

(52) U.S. Cl. 522/149

(57) ABSTRACT

Crystalline, absorbable, polyaxial copolymers prepared using, for example, ε-caprolactone and glycolide, were tipped with methacrylate groups and photopolymerized into crystalline, absorbable solid constructs under typical conditions for stereolithography.

This application claims the benefit of prior provisional application U.S. Serial No. 60/417,376, which was filed on Oct. 9, 2002.

### FIELD OF THE INVENTION

The invention relates to photopolymerizable, crystalline, absorbable polymers for the production of dimensionally stable crystalline solid or microporous absorbable devices using stereo lithography.

### BACKGROUND OF THE INVENTION

For rapid prototype manufacturing of a range of devices and the production of microdevices for biomedical applications, a stereolithography apparatus (SLA) has been consistently used to obviate the need for expensive parts to prepare such devices by traditional injection molding or micromachining. The SLA is designed for in situ, incremental, three-dimensional formation of solid, crosslinked cross-sections of the desired device using a liquid mixture of photopolymerizable monomeric and/or oligomeric intermediates carrying, on the average, more than one photoactive, unsaturated group per molecule in the presence of a photo-initiator and suitable focused UV or visible light sources [Gilding & Reed, Polymer, 20, 1459, (1979)]. A device, or part thereof is prototyped with computer aided design (CAD). SLA software slices the prototyped part into cross-sections and a focused UV or visible light laser cures the photoactive intermediates [Dittrich & Schulz, Angew. Makromol. Chem., 15, 109 (1971)]. Key advantages of using SLA are (1) a dramatic reduction in time from product conceptualization to producing a prototype compared with other more traditional polymer processing techniques that require expensive parts and tools; and (2) having a high purity prototype that is ready to use. However, prototypes made using SLA do suffer from a number of serious disadvantages, including (1) the fact that all known photoactive intermediates result in amorphous, glassy, brittle parts that require tedious purification and are difficult to evaluate for the intended applications; and (2) limited availability of photo-reactive intermediates for producing prototypes, which are not glassy but partially crystalline and exhibit a reasonable degree of impact strength, for the fast-growing area of absorbable parts and devices as well as scaffolds for use in tissue engineering. To address the first problem, photo-reactive, flexible intermediates for use in conjunction with presently used ones to produce internally plasticized, impact-resistant prototypes have been developed as described in the prior art [Shalaby et al., U.S. Pat. Nos. 5,691,444 (1997), U.S. Pat. No. 5,780,580 (1998)]. Unfortunately, there has been no solution to the present inability to produce absorbable crystalline prototypes. To address the application of SLA for the production of absorbable articles, recent investigators prepared a number of liquid photoactive, absorbable, polymeric intermediates and produced crosslinked, glassy articles [Matsuda and Mizutani, J. Biomed. Mater. Res., 62, 395 (2002) and references therein]. However, none of the authors disclosed the use of crystalline, oligomeric and/or polymeric absorbable photoactive intermediates and their conversion using SLA to semicrystalline, crosslinked articles with sufficient impact strength and dimensional stability to allow adequate evaluation for intended applications including their use as scaffolds for tissue engineering. Accordingly, elements of the present invention were conceived using SLA for the rapid prototyping of absorbable devices or parts thereof using crystalline photoactive oligomeric and/or polymeric intermediates. This invention is also intended to provide a means to construct crystalline, microporous, absorbable, high-purity scaffolds for use in tissue engineering.

### SUMMARY OF THE INVENTION

The present invention deals with the preparation of crystalline, polyaxial, absorbable polymers having methacrylate terminals to allow their photopolymerization using stereo lithography into solid or microporous crystalline dimensionally stable medical devices or scaffolds for tissue engineering.

Thus, the present invention is directed to a photopolymerizable, ester-based, crystalline, absorbable polymer having a melting temperature of less than about 200° C., which includes at least two photopolymerizable double bonds per molecule. In a preferred embodiment the crystalline polymer has a polyaxial configuration. A preferred polyaxial polymer in accordance with the present invention is the reaction product of at least one cyclic monomer such as caprolactone, glycolide, lactide, trimethylene carbonate or 1,5-dioxapan-2-one and a polyaxial initiator having at least three branches, each branch having a reactive group such as an hydroxyl group of an amine group, such that the polymer has at least three chains, each chain having a proximal end at the polymer core, which is derived from the initiator, and each chain having a terminal end extending outwardly from the core, the polymer having one chain for each branch of the polyaxial initiator. Preferred polyaxial initiators include trimethylol-propane and triethanolamine. Preferably the photopolymerizable double bonds are at the chain terminals and are derived from an end-capping moiety such as a methacrylic acid derivative.

In another aspect the present invention is directed to a crystalline, absorbable, crosslinked article made by a process which includes the steps of providing a photopolymerizable, ester-based crystalline polymer having a melting temperature of less than about 200° C., which has at least two photopolymerizable double bonds per molecule, and subjecting the polymer to a light source in the presence of a photoinitiator. Preferred light sources include UV light and visible light. Preferably the step of subjecting the polymer to a light source in the presence of a photoinitiator occurs in a stereolithography apparatus. The resultant article may be a solid or a continuous cell microporous construct having an average pore diameter between about 10 and 500 μm. The latter is useful in tissue engineering.

### DETAILED DESCRIPTION OF THE PREFERRED EMBODIMENTS

This invention deals, in general, with photoactive, absorbable, crystalline, ester-based polymers that melt or liquefy below 200° C. and preferably below 100° C. and more preferably below 60° C. and can be converted by photo-polymerization into dimensionally stable, absorbable, crystalline prototypes of biomedical devices or parts thereof and microporous scaffolds for use in tissue engineering. Another aspect of this invention deals with low molecular copolyesters with more than one photopolymerizable double bond per chain and preferably more than two double bonds per chain. Another aspect of this invention deals with low molecular weight, polyaxial (i.e., having a central nitrogen or carbon atom with three or four branches extending from the center) copolyester with terminal groups comprising photopolymerizable double bonds produced by the condensation of a reactive methacrylate derivative with a hydroxy-terminated polyaxial copolyester. The latter can be made by the polymerization of one or more cyclic monomer, known as precursors of absorbable polymers, in the presence of a multifunctional polyaxial initiator bearing three or more primary hydroxyl or amine groups such as trimethylolpropane (TMP) and triethanolamine. A specific aspect of this invention deals with a polyaxial polymer intermediate made by reaction of triethanolamine, trimethylolpropane, or similar polyol, and one or more cyclic monomer such as ε-caprolactone, trimethylene carbonate, glycolide, lactide, or 1,5-dioxepan-2-one. A specific aspect of this invention deals with an absorbable, low molecular weight, polyaxial caprolactone/glycolide copolymer comprising up to three methacrylate end-groups and melts below 65° C. and preferably melts below 55° C. and more preferably melts below 50° C. Another aspect of this invention deals with a photocurable composition comprising one or more low molecular methacrylate-terminated copolyester, which melts below 65° C. and carries a sufficient number of said methacrylate terminal groups to support curing by diffused or focused UV radiation to a crosslinked system in the presence of one or more photo-initiators (PIs) including, but not limited to, compounds such as 2,2-dimethoxy-2-phenyl-acetophenone. In another aspect of this invention, moderate and high molecular linear or polyaxial copolyesters are prepared with two or more methacrylate terminal groups and melt between 35° C. and 200° C. for use as reactive solutes in low melting photo-crosslinkable compositions based on lower molecular polyaxial polyesters with up to four methacrylate end-groups, wherein said high molecular solute becomes an integral part of the crosslinked, cured system to improve its impact strength and other related physicomechanical properties. Another aspect of this invention deals with polymerizable precursors of solid medical devices, components of medical devices, or solid prototypes thereof that are made from two or more cyclic monomer such as ε-caprolactone, trimethylene carbonate, p-dioxanone, 1,-5-dioxepan-2-one, glycolide, and any of the lactide isomers. A specific aspect of this invention deals with a polyaxial precursor made by polymerizing ε-caprolactone or a mixture of ε-caprolactone and trimethylene carbonate in the presence of a trihydroxy compound such as trimethylolpropane and preferably triethanolamine acid. A more specific aspect of this invention deals with a methacrylate-terminated polyaxial precursor made of ε-caprolactone or more than 90 percent ε-caprolactone and the balance being a glycolide or dl-lactide that have a molecular weight, as determined by gel permeation chromatography (GPC), to be less than 10 kDa and preferably less than 6 kDa, wherein said copolymer is made by polymerizing the cyclic monomer or monomers using stannous octanoate (St.Oct.) as a catalyst and trimethylolpropane and preferably triethanolamine as an initiator. Another aspect of this invention deals with using a mixture of two or more initiators including an alkanediol, triethanolamine, pentaerythritol, and trimethylolpropane. Another aspect of this invention deals with a method for curing a typical precursor to a solid, crosslinked system using UV or visible light, but preferably focused UV and more preferably a laser UV that is part of a stereography apparatus equipped with the appropriate suitable radiation source to produce a prototype of a desired biomedical device or parts thereof or a microporous, continuous cell scaffold for use in tissue engineering. Another specific aspect of this invention deals with a microporous, crystalline scaffold made by the photo-polymerization of crystalline, polyaxial intermediates, wherein the microporous structure has a continuous cell structure having an average pore diameter of 10 to 500 μm for use in soft and hard tissue engineering.

More illustrative examples of this invention are outlined below:

### EXAMPLE 1

### Preparation and Properties of Polyaxial, Ester-Based Hydroxy Terminated Polymers (TP): General Method

Using a standard method for ring-opening polymerization [Shalaby, U.S. Pat. No. 6,462,169 (2002)], ε-caprolactone, with and without glycolide, was heated under a dry nitrogen atmosphere at 160° C. in the presence of a predetermined amount of TMP and SnOct to achieve the desired molecular weight. The polymerization was continued until negligible amounts of monomer could be detected using gel-permeation chromatography (GPC). Trace amounts of monomer were removed by heating at 110° C. under reduced pressure. The polymer was characterized for molecular weight (GPC), identity (IR and NMR), and thermal properties (DSC). A list of typical examples of TPs and their properties is provided in Table I.

TABLE I
Key Properties of Typical Polyaxial, Hydroxy-terminated
Polymers (TPs)

| Polymer^{a} | Mₙ × 10⁻³ | M_{w} × 10⁻³ | Tₘ, ° C. | ΔH_{f}, J/g |
|---|---|---|---|---|
| TP-1-1 | 92.80 | 136.20 | 60 | 111 |
| TP-1-2 | 20.60 | 25.40 | 58 | 86 |
| TP-1-3 | 8.35 | 9.47 | 53 | 78 |
| TP-1-4 | 5.06 | 5.59 | 46 | 79 |
| TP-1-5 | 3.92 | 4.42 | 40 | 54 |
| TP-2-1 | 6.78 | 8.71 | 48 | 65 |

^{a}TP-1 = polycaprolactone,; TP-2 = 95/5 caprolactone/glycolide copolymer.

### EXAMPLE 2

### Methacrylate-Capping of TPs: General Method

This was conducted by reacting the specific polyaxial polymer with methacryloyl chloride in dichloromethane (DCM) in the presence of triethylamine as an acid receptor. The reaction was conducted at room temperature for 24 hours. The reaction product was concentrated and solid byproducts were isolated by filtration. Volatile components of the filtrate were evaporated under reduced pressure to yield the methacrylated product. This was characterized as described above for the polyaxial polymers.

### EXAMPLE 3

### Preparation and Testing of Photo-Crosslinked Methacrylated Polymers

Crystalline methacrylated polymer lots were mixed with different quantities of the photo-initiator (PI) at 65° C. The mixture was transferred to a special mold (7.9 mm deep) then kept at about 72° C. to maintain the polymer in the molten state while being irradiated with UV. After placing a BLAK-RAY 365 nm UV lamp at 6 mm distance from the molten polymer, irradiation was pursued for the required period of time. Then the specimens were cooled and isolated from the mold, cut into microtensile specimens, and tested for their thermal and mechanical properties as well as extent of crosslinking. The latter was determined in terms of weight percent of non-extractable components in DCM. The respective data are summarized in Tables II and III.

TABLE II
Thermal Properties of TP-2-1 after Methacrylation and
Irradiation under Different Conditions

| % PI | Cure Time, Sec. | Tₘ, ° C. | ΔH_{f}, J/g |
|---|---|---|---|
| 0.5 | 0 | 46 | 54 |
| 0.5 | 45 | 45 | 51 |
| 0.6 | 60 | 46 | 51 |
| 0.7 | 60 | 46 | 49 |
| 0.6 | SLA 30 passes | 43 | 43 |

TABLE III
Mechanical Properties of TP-1-5 and TP-2-1 after
Methacrylation and Irradiation under Different Conditions

| Photo- | | | | | |
|---|---|---|---|---|---|
| polymerization | | | | | |
| Conditions | | Mechanical Properties | | | |
| % | Irradiation | Max. Stress | % | Modulus | % |
| PI | Time, Sec. | (MPa) | Elongation | (MPa) | Crosslinking |

For Methacrylated TP-1-5

| | | | | | |
|---|---|---|---|---|---|
| 0.01 | 120 | 2.76 | 0.9 | 526 | 47 |
| 0.1 | 120 | 4.15 | 1.4 | 441 | — |
| 0.5 | 120 | 5.92 | 1.3 | 665 | — |
| 0.5 | 90 | 5.51 | 1.9 | 524 | — |
| 0.5 | 45 | 4.47 | 1.3 | 470 | 56 |
| 0.05 | 90 | 4.97 | 1.6 | 423 | 51 |

For Methacrylated TP-2-1

| | | | | | |
|---|---|---|---|---|---|
| 0.5 | 60 | 3.98 | 2.8 | 206 | 66 |
| 0.6 | 45 | 5.01 | 2.6 | 342 | — |

### EXAMPLE 4

### Photo-Crosslinking Using an SLA

This was conducted using an SLA laboratory model on a representative polymer system (MTP-2) at 50° C. A minimum of 25 passes was required to achieve a sufficient degree of crosslinking. In the present study, the experiments were conducted using 30 passes.

Preferred embodiments of the invention have been described using specific terms and devices. The words and terms used are for illustrative purposes only. The words and terms are words and terms of description, rather than of limitation. It is to be understood that changes and variations may be made by those of ordinary skill art without departing from the spirit or scope of the invention, which is set forth in the following claims. In addition it should be understood that aspects of the various embodiments may be interchanged in whole or in part. Therefore, the spirit and scope of the appended claims should not be limited to descriptions and examples herein.

What is claimed is:

1. A photopolymerizable, ester-based, crystalline, absorbable polymer having a melting temperature of less than about 200° C., comprising at least two photopolymerizable double bonds per molecule.

2. The photopolymerizable crystalline polymer set forth in claim 1 comprising a polyaxial configuration.

3. The photopolymerizable crystalline polymer set forth in claim 2 comprising the reaction product of at least one cyclic monomer selected from the group consisting of caprolactone, glycolide, lactide, trimethylene carbonate and 1,5-dioxapan-2-one and a polyaxial initiator comprising at least three branches, each branch comprising a reactive group selected from hydroxyl and amine groups, such that the polymer comprises at least three chains, each chain comprising a proximal end at the polymer core, wherein the core is derived from the initiator, and each chain comprising a terminal end extending outwardly from the core, the polymer comprising one chain for each branch of the polyaxial initiator

4. The photopolymerizable crystalline polymer set forth in claim 3 wherein the polyaxial initiator is selected from the group consisting of trimethylol-propane and triethanolamine.

5. The photopolymerizable crystalline polymer set forth in claim 3 wherein the photopolymerizable double bonds are at the chain terminals and are derived from an end-capping moiety.

6. The photopolymerizable crystalline polymer set forth in claim 5 wherein the end-capping moiety comprises a methacrylic acid derivative.

7. The photopolymerizable crystalline polymer set forth in claim 3 wherein the at least one cyclic monomer comprises caprolactone.

8. A crystalline, absorbable, crosslinked article made by the process comprising the steps of:
providing a photopolymerizable, ester-based crystalline polymer having a melting temperature of less than about 200° C., comprising at least two photopolymerizable double bonds per molecule; and
subjecting the polymer to a light source in the presence of a photoinitiator.

9. A crystalline, absorbable, crosslinked article made by the process set forth in claim 8 wherein the light source comprises UV light.

10. A crystalline, absorbable, crosslinked article made by the process set forth in claim 8 wherein the light source comprises visible light.

11. A crystalline, absorbable, crosslinked article made by the process set forth in claim 8 wherein the step of subjecting the polymer to a light source in the presence of a photoinitiator occurs in a stereolithography apparatus.

12. A crystalline, absorbable, crosslinked article made by the process set forth in claim 11 wherein the article comprises a solid.

13. A crystalline, absorbable, crosslinked article made by the process set forth in claim 11 wherein the article comprises a continuous cell microporous construct having an average pore diameter between about 10 and 500 μm.

14. A crystalline, absorbable, crosslinked article made by the process set forth in claim 13 for use in tissue engineering.
